(19) United States
(12) Patent Application Publication
(10) Pub. No.: US 2008/0262878 A1
(43) Pub. Date: Oct. 23, 2008

(54) SYSTEMS, METHODS, AND COMPUTER PROGRAM PRODUCTS FOR GENERATING AND UPDATING A CACHE OF PRICE AND AVAILABILITY INFORMATION FOR TRAVEL PACKAGES AND COMPONENTS

(75) Inventors: Richard Webby, West New York, NJ (US); Joshua Hartmann, Brooklyn, NY (US); David Yong, New York, NY (US)

Correspondence Address: Alston & Bird LLP;Bank of America Plaza, 101 South Tryon Street, Suite 4000, Charlotte, NC, 28280-4000, US

(73) Assignee: Travelocity.com LP, Southlake, TX (US)

(21) Appl. No.: 11/736,291

(22) Filed: Apr. 17, 2007

(51) Int. Cl. G06Q 10/00

(52) U.S. Cl. 705/5

(57) ABSTRACT

Systems, methods, and computer program products are provided for generating, updating, and managing a cache of price and availability information for a plurality of travel packages and components. The cache of price and availability information may then be searched by an online travel planning service to provide customers with a list of available travel products. More particularly, embodiments of the present invention provide a cascading cache system including a cache of price and availability data related to travel components and a cache of price and availability data related to travel packages. Changes made to the component cache can affect information stored in the package cache, and changes made to the package cache can affect information stored in the component cache. Furthermore, the cache system updates the package and component caches based on information received from a purchase of a package or component, as well as by proactively polling one or more travel reservation systems.

### FIELD OF THE INVENTION

Embodiments of the present invention relate generally to systems, methods, and computer program products for generating and updating a cache of price and availability information for a plurality of travel products.

### BACKGROUND OF THE INVENTION

Many travelers now make their vacation plans or business travel plans using web-based travel services to purchase or otherwise reserve one or more travel products. Such travel products may include for example, airline reservations, hotel reservations, car rental reservations, dinner reservations, cruise reservations, sports tickets or other event tickets or reservations, limousine service reservations, tour reservations, and the like. The travel products may also include travel packages that combine two or more travel components such as those listed above.

Typically, a web-based service allows a customer to search for price and availability information for one or more travel products given a particular travel date or range of travel dates. The web-based service may provide the price and availability information by accessing the reservation system(s) for each possible provider of the travel product and searching for price and availability information on these reservation systems. For example, one such reservation system may be a Global Distribution System (GDS), such as SABRE. A GDS, also commonly referred to as a Computer Reservation System (CRS), is a system that compiles real-time price and availability information for a number of travel products and travel providers and then provides this information to travel agents or other travel services in response to queries from the travel agents or services. A GDS also typically processes reservation requests or purchase requests for the travel products. Although, a GDS is typically one of the most comprehensive collections of real-time travel product price and availability information, the costs of requesting the real-time price and availability information from the GDS each time a customer searches for a travel product can be high in terms of both monetary cost and/or processing costs and delays.

For example, suppose a customer of a web-based travel service submits a request for price and availability information about a hotel. Such a request typically includes certain requested criteria, such as a given geographic area, a date of arrival, and a length of stay. In response to such a request, a conventional web-based travel service may provide the customer with upwards of 50 to 100 different hotels meeting the customer's query and may provide separate price and availability information for each class of room (e.g., queen, king, suite, room-with-a-view, etc.) offered by each hotel. Thus, the conventional web-based service would have to submit a separate GDS request for each combination of hotel and class of room. As a result, the web-based travel service may need to submit hundreds or even thousands of GDS requests in order to respond to the one hotel request from the one customer. As is apparent, the processing time required to poll the reservation system and assemble this information may be excessive to the point that the time delay it is not acceptable to the customer.

To address this problem, modem web-based travel services often build a cache of the best priced travel products and then search this cache for price and availability information for a customer. The travel service may build this cache by periodically polling the GDS and/or other travel product reservation systems and databases. In this way, the travel services can search for price and availability information about a particular travel product and respond to a customer request for such information faster and cheaper than polling the GDS or other reservation systems each time a customer submits a search request. For example, U.S. patent application Ser. No. 10/635,273 to Hartmann et al. and assigned to TRAVELOCITY.COM, describes systems and methods for pre-populating a cache of product availability information to use for efficiently handling product availability queries.

Unfortunately, there remain several problems with a caching system. For instance, by using a cache of information obtained from a reservation system at some earlier time, the cached information is not real-time information and, therefore, may quickly become out-of-date. This may be particularly true in the travel industry where price and availability information for travel products can change very quickly and drastically. As a result, in a caching system a customer may sometimes experience a price jump or a sudden change in availability of a travel product when the customer tries to purchase the product. For example, a customer browsing travel products on a web-based travel service may actually be looking at cached price and availability data that was retrieved from a GDS the night before. When the customer goes to purchase a travel product, the web-based travel service may then contact the GDS again to confirm the price and availability information for the purchase. If the information has changed between the time that the cache was recorded and the time of the purchase, the customer may experience a jump in the price between the price that the customer had been viewing and the price that the customer now is asked to pay to reserve the travel product.

Furthermore, generating a complete cache of price and availability information for many different travel products requires making enormous amount of requests to the GDS or other reservation systems. Large amounts of requests can crash or at least put a substantial strain on the reservation systems. As a result, some reservation systems may require that the web-based travel services only submit requests during off-peak hours. Unfortunately, the off-peak time is generally not long enough to submit all of the requests required to adequately populate and/or update the travel product cache.

The problems described above are often more pronounced when generating a cache of travel packages. Recently, several web-based services now provide customers with a plurality of discounted travel packages that may include a combination of individual travel components, such as airline tickets, a hotel stay, a rental car, and/or other travel components combined into a discounted travel package. In order to generate a cache of travel packages, however, the web-based service must submit even more requests to the GDS or other reservation systems since there are so many possible combinations of travel components that may make up a travel package. As a result, customers may experience even more price jumps or sudden unavailability notices when trying to purchase travel packages.

In light of these issues, systems, methods, and computer program products are needed that provide product price and availability information from various product sources to a customer in a more timely manner, while also ensuring that the availability and pricing information is substantially current and accurate. Such systems, methods, and computer products should also be able to provide product package information in a timely manner and should not unduly strain the reservation systems from which travel product information is obtained.

### BRIEF SUMMARY OF THE INVENTION

Systems, methods, and computer program products are provided for generating, updating, and managing a cache of price and availability information for a plurality of travel packages and travel components. The cache of price and availability information may be searched by an online travel planning service to provide customers with a list of available travel products. More particularly, embodiments of the present invention provide a cascading cache system including a cache of price and availability data related to travel components and a cache of price and availability data related to travel packages. Changes made to the component cache can affect information stored in the package cache, and changes made to the package cache can affect information stored in the component cache. Furthermore, the cache system updates the package and component caches based on information received from a purchase of a package or component, as well as by polling one or more travel reservation systems.

For example, embodiments of the present invention provide a system for generating and/or updating price and availability information of travel packages, each travel package comprising a combination of at least two travel components. The system generally includes a memory system configured for storing data. The system also includes a component cache manager module configured for managing a component cache of price and availability information for each of a plurality of travel components. The component cache may be stored within the memory system. The system also includes a package cache manager module in operative communication with the component cache manager module and configured for managing a package cache of price and availability information for each of a plurality of travel packages. The package cache may be stored within the memory system. The package cache manager module may be configured to receive an indication of a change made to price and availability information in the component cache. The package cache manager module may be configured to update or generate price and availability information of a package in the package cache based on the change to the component cache.

In one embodiment, the system further includes a polling module in operative communication with the component cache manager module and configured for polling one or more travel product reservation systems, such as a Global Distribution System (GDS), in order to receive current price and availability information about one or more travel components. The component cache manager module may be configured to use the polling module to periodically update at least some of the component cache. In this regard, the component cache manager module may be configured to use the polling module to update an item of information in the component cache when the item of information has not been updated for a predetermined amount of time. The component cache manager module may also be configured to update at least some of the component cache based on information received about a purchase or reservation of at least one travel component.

In one embodiment, the package cache manager module is configured to update the package cache based on information received about a purchase or reservation of a package. In such an embodiment, the information received about a purchase or reservation of a package may also be used to update the component cache.

The system of claim 1, may also include a sub-component cache manager module in operative communication with the component cache manager module. The sub-component cache manager module may be configured for managing a sub-component cache of price and availability information for each of a plurality of travel sub-components. The sub-component cache may be stored within the memory system. The component cache manager module may be configured to receive an indication of a change made to the sub-component cache. The component cache manager module may also be configured to generate or update the price and availability information of a travel component in the component cache based on the change made to the sub-component cache.

The system may also include a rules manager module configured for managing a plurality of package rules and/or other cache management rules. The package rules may also be stored in the memory system. The package cache manager module may then generate or update travel packages in the package cache according to the package rules.

In one embodiment, the system includes a services interface configured to receive, from a requesting entity, requests for price or availability information for one or more travel components or travel packages. The services interface may be further configured to use the component cache manager module or the package cache manager module to search for the requested price or availability information in the component cache or the package cache. The services interface may then be configured to provide price or availability information to the requesting entity in response to the request. In one embodiment, the requesting entity is a travel planning system, such as a web-based travel service.

Embodiments of the present invention further provide a method for generating and/or updating price and availability information of travel packages, each travel package comprising a combination of at least two travel components. The method may include: (1) providing a memory system configured for storing data; (2) storing in the memory system a component cache of price and availability data for a plurality of travel components; (3) storing in the memory system a package cache of price and availability data for a plurality of travel packages; and (4) updating or generating price and availability information of a package in the package cache based on a change to the component cache.

The method may further include: polling one or more travel product reservation systems in order to receive current price and availability information about one or more travel components; and updating or generating at least some of the price and availability information in the component cache based on the received current price and availability information. In this regard, the method may involve polling one or more travel product reservation systems to update an item of information in the component cache when the item of information has not been updated for a predetermined amount of time. The method may also involve updating at least some of the component cache based on information received about a purchase or reservation of at least one travel component.

In one embodiment, the method includes updating the package cache based on information received about a purchase or reservation of a package. The method may further include using the information received about a purchase or reservation of a package to update the component cache.

In one embodiment, the method includes storing in the memory system a sub-component cache of price and availability information for a plurality of travel sub-components. Such an embodiment may also include generating or updating price and availability information of a component in the component cache based on a change made to the sub-component cache.

The method may include storing a plurality of package rules in the memory system; and generating or updating travel packages in the package cache according to the package rules.

The method may further include receiving, from a requesting entity, requests for price or availability information for one or more travel components or travel packages. In such an embodiment, the method may include searching for the requested price or availability information in the component cache or the package cache. The method may then include providing price or availability information to the requesting entity in response to the request.

Embodiments of the present invention may also provide for a computer program product for generating and/or updating price and availability information of travel packages, each travel package comprising a combination of at least two travel components. The computer program product may include at least one computer-readable storage medium having computer-readable program code logic stored therein. In general, the computer-readable program code logic includes code logic configured for executing various aspects of the method described above, in accordance with embodiments of the present invention. For example, the computer program product may include: (1) a first code logic configured for storing in a memory system a component cache of price and availability data for a plurality of travel components; (2) a second code logic configured for storing in the memory system a package cache of price and availability data for a plurality of travel packages; and (3) a third code logic configured for updating or generating price and availability information of a package in the package cache based on a change to the component cache.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an illustration of a generalized network environment in which systems, methods, and computer program products of embodiments of the present invention may be implemented; FIG. 1 further provides a block diagram of a travel product cache system, in accordance with one embodiment of the present invention;

FIG. 2 provides a block diagram of a system for providing a customer with price and availability information about one or more travel products in response to a request from the customer, in accordance with one embodiment of the present invention;

FIG. 3 provides a block diagram of a system for reserving one or more travel products in response to a customer's reservation request, in accordance with one embodiment of the present invention;

FIG. 4 provides a block diagram of a system for generating and updating a cache of price and availability information for a plurality of travel products, in accordance with one embodiment of the present invention; and

FIG. 5 provides a flow diagram illustrating a method of generating and/or updating price and availability information in the cache of FIG. 4, in accordance with one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

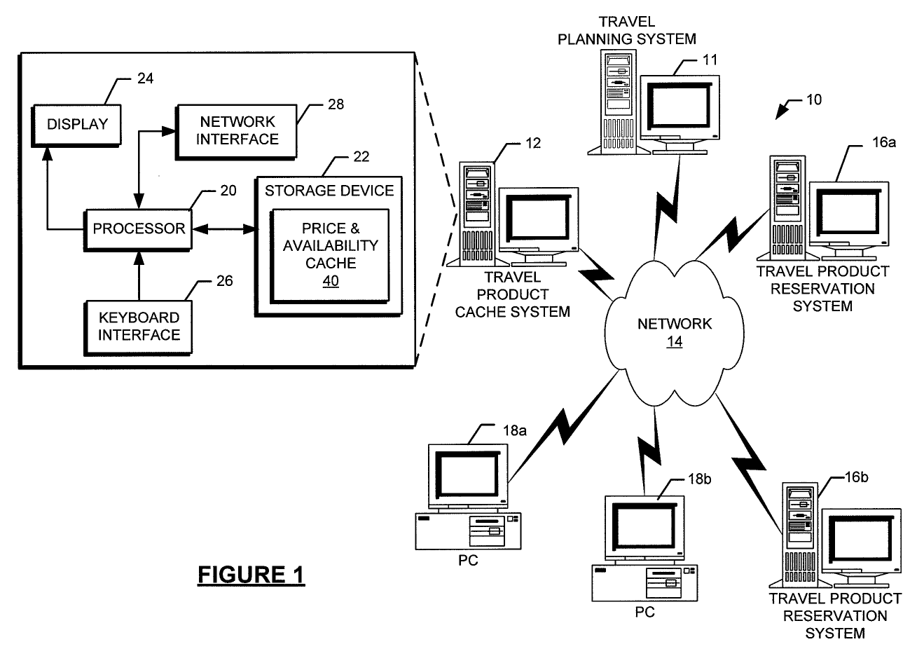

FIG. 1 is an illustration of a generalized network environment in which the systems, methods, and computer program products of embodiments of the present invention may be implemented. Specifically, a system 10 of one embodiment of the present invention includes a travel planning system 11. The travel planning system 11 may include one or more computers, servers, or mainframe systems and typically operates a customer interface that allows a customer to search for price and availability information for one or more travel products. As used herein, a “travel product” may be a travel package or a travel component, where a “travel package” is a combination of two or more travel components. A travel component may include, for example, an airline reservation, a hotel reservation, a car rental reservation, a dinner reservation, a cruise reservation, a ticket to a sporting event or other event, a limousine service reservation, a tour reservation, and the like. Thus, a travel package may include, for example, an airline ticket, a hotel reservation, and a car rental reservation all packaged together, often at a price that is discounted below the sum of the prices of the individual travel components. Although FIG. 1 illustrates only one travel planning system 11, in some embodiments, the system 10 may include a plurality of travel planning systems 11.

In the illustrated embodiment, the travel planning system 11 is connected to a network 14, such as a LAN, a WAN, an intranet, or the Internet. In one embodiment, the travel planning system 11 hosts a website on the network 14. In such an embodiment, a customer operating a personal computer (PC) 18 or other device that is connected to the network 14 may use a web browser to access the travel planning system's website to search for price and availability information regarding one or more travel products. As illustrated in FIG. 1, in one embodiment, multiple PCs, such as PC 18a and PC 18b, are connected to the network and may be able to access the travel planning system 11 simultaneously.

The system 10 illustrated in FIG. 1, further includes one or more travel product reservation systems 16, such as systems 16a and 16b. Each travel product reservation system 16 may include one or more computers, servers, or mainframe systems. Each travel product reservation system 16 is communicatively coupled to the network 14. In general, each travel product reservation system 16 provides up-to-date, “real-time,” or near real-time price and availability information about one or more travel products. Furthermore, each travel product reservation system 16 typically allows for an entity to purchase or reserve travel products through the travel product reservation system 16. For example, in one embodiment, the travel product reservation system 16 is a Global Distribution System (GDS), such as SABRE, AMADEUS, GALILEO, WORDLSPAN, and the like. A GDS, also commonly referred to as a Computer Reservation System (CRS), provides a user with access to up-to-date price and availability information, as well other information, about one or more travel products. A GDS also typically allows a customer to purchase or reserve the travel products through the GDS. As used herein, unless stated otherwise, “reserving” a travel product may include purchasing the travel product. Typically, a GDS provides access to a variety of different travel components such as airline, hotel, and rental car reservations. In one embodiment, the GDS charges a fee for access to the information provided by the GDS.

Other types of travel product reservation systems 16 may include reservation systems offered by the actual provider of a travel product, such as a reservation system provided by a particular hotelier, airline, rental car company, cruise line, tour operator, railroad, travel insurance carrier, and the like. The travel product reservation system 16, however, need not be operated by the provider of a travel product and, instead, may be operated by an intermediary entity between the customer and the provider of the travel product. In one embodiment, where the network 14 is the Internet, one or more travel product reservation systems 16 may provide access to a product's price and availability information through a web page.

As illustrated in FIG. 1, the system 10 further includes a travel product cache system 12 that may be communicatively coupled to one or more travel product planning systems 11 and one or more travel product reservation systems 16 via the network 14. Although not shown, in other embodiments, the travel product cache system 12 may be directly coupled to the travel product planning system 11. In one exemplary embodiment, the travel product cache system 12 is integrated into the travel planning system 11. Similarly, the travel planning system 11 and/or the travel product cache system 12 may be directly connected to either or both of the computing systems 16 and 18, for example, in embodiments in which a network 14 is not used to access the travel planning system 11.

As illustrated in the exploded portion of FIG. 1, the travel product cache system 12 is generally embodied as a typical computer, server, or mainframe system. In this regard, the system 12 generally includes a processing element 20, such as a microprocessor, VLSI, ASIC, etc., a storage device 22, a display 24, a keyboard interface 26, and a network interface 28.

As mentioned above, an aspect of embodiments of the present invention is the generation and updating of a cache from which price and availability information is generally derived to be used in responding to customer requests. Specifically, as shown in FIG. 1, the travel product cache system 12 includes a price and availability cache 40 located in the storage device 22. The price and availability cache 40 is populated with product price and availability information needed to properly respond to travel product requests issued by customers. FIG. 1 illustrates the price and availability cache 40 stored in the storage device 22 located in the travel product cache system 12. However, in other embodiments, the cache 40 could be stored in an external storage device communicatively coupled to the travel product cache system 12. For example, the cache 40 could be stored in a remote storage device that is connected to the travel product cache system 12 via a network. The various operations of the present invention may be performed either by hardware in the form of ASIC chips or other specialized hardware or by operation of software ran by a processing element. In the latter case, the storage device 22 may also further include the various computer software programs and modules used to implement the operations of embodiments of the present invention.

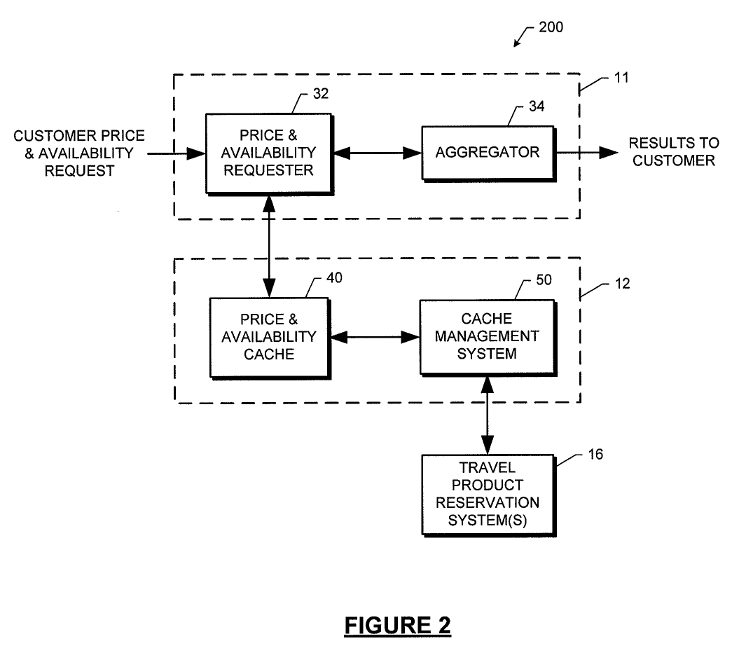

FIG. 2 provides a block diagram of a system 200 for providing a customer with price and availability information about one or more travel products in response to a request from the customer, in accordance with one embodiment of the present invention. In the illustrated embodiment, the system 200 provides a customer with price and availability information using the system 10 illustrated in FIG. 1. The blocks illustrated in FIG. 2 may be implemented either as hardware, software, and/or a combination of both hardware and software. As illustrated in FIG. 2, the travel planning system 11 includes a price and availability requester 32 for receiving price and availability requests from a customer. For example, in one embodiment, the travel planning system 11 hosts a web page on the network 14. In such an embodiment, the process of the price and availability requester 32 receiving price and availability requests from a customer may involve the customer accessing the web page and entering such information as a geographic area, a period of time, an indication of the desired travel product(s), and the like into a form provided on the web page.

The price and availability requester 32 is connected to the price and availability cache 40 for performing price and availability queries thereon. In other words, in one embodiment, when the price and availability requester 32 receives a request from the customer for information regarding one or more travel products, the price and availability requester 32 may be configured to search the price and availability cache 40 for information about the one or more travel products requested by the customer. As described above, the price and availability cache 40 may be stored in a storage device 22 of the travel product cache system 12. Thus, where the price and availability requester 32 is a component of the travel planning system 11, the price and availability requester 32 may be communicatively coupled to the price and availability cache 40 by the network 14. As described above, in one embodiment, the travel product cache system 12 makes the price and availability cache 40 available to the travel planning system 11 for searching. In other embodiments, however, the price and availability requester 32 of the travel planning system 11 merely receives a customer's request and communicates the customer's request to the travel product cache system 12 where a search module of the travel product cache system 12 then searches the price and availability cache 40. In such an embodiment, the price and availability requester 32 may also convert the received customer request into a form that can be received by a search module of the travel product cache system 12.

As illustrated in FIG. 2, the travel planning system 11 may further include an aggregator 34 communicatively coupled to the price and availability requester 32. The aggregator 34 is configured to gather the various responses generated by the availability requester 32 querying the price and availability cache 40. The aggregator 34 amasses the responses and outputs the price and availability results to the customer. In this regard, the aggregator 34 may be configured to present the price and availability information to the customer by displaying the price and availability information on a web page or by communicating the information in some other type of electronic form.

As further illustrated by FIG. 2, the travel product cache system 12 may further include a cache management system 50. The cache management system 50 is communicatively coupled to the price and availability cache 40 and manages the populating and updating of the cache 40. The cache management system 50 may also be communicatively coupled to one or more of the travel product reservation systems 16 via the network 14 or via some other connection. As described in greater detail below, the cache management system 50 may populate and/or update at least a portion of the cache 40 by gathering information from the one or more travel product reservation systems 16. For example, the cache management system 50 may periodically “poll” the one or more travel product reservation systems 16 by constructing and running price and availability queries on the one or more travel product reservation systems 16. The cache management system 50 may then store any received price and availability information in the cache 40. It is understood that the functions performed by the availability requester 32, the aggregator 34, and the cache management system 50 may all be performed by specialized hardware and/or by one or more processing elements, such as processing element 20, executing appropriate software. It is understood that in other embodiments, the travel product reservation systems 16 may be configured to “push” information to the cache management system 50.

In an exemplary embodiment of the system 200, the travel planning system 11 may be configured to allow customers to search for the best priced hotels available in a certain area on certain dates. In such an embodiment, the cache management system 50 may be configured to periodically poll the reservation system(s) 16 provided by a GDS and/or by one or more of different hoteliers. In response to the cache management system's requests to the reservations system(s) 16, the cache management system 50 may receive up-to-date information about the price and availability of various different classes of rooms offered by each hotel. The cache management system 50 may then store the received price and availability information as cache 40 in a storage device 22. A customer who desires to stay in a hotel in the near future may submit a request for hotel information to the travel planning system 11. Submitting this request may involve the customer accessing a particular web page hosted by the travel planning system 11 and entering such information as a geographic location, an arrival date, a length of stay, a class of hotel, a type of room, and/or the like, into a form on the web page. The price and availability requester 32 of the travel planning system 11 may then access the travel product cache system 12 in order to search the price and availability cache 40 for price and availability information about hotels that meet the customer's requested criteria. The aggregator 34 of the travel planning system 11 may then accumulate all of the results into a user-friendly format and present them to the customer on a web page within moments of the customer entering the price and availability request. The customer may then browse the results and, if the customer sees a hotel and a price that meets his or her needs, the customer may submit a request to the travel planning service 11 to reserve the hotel for the customer on the requested dates.

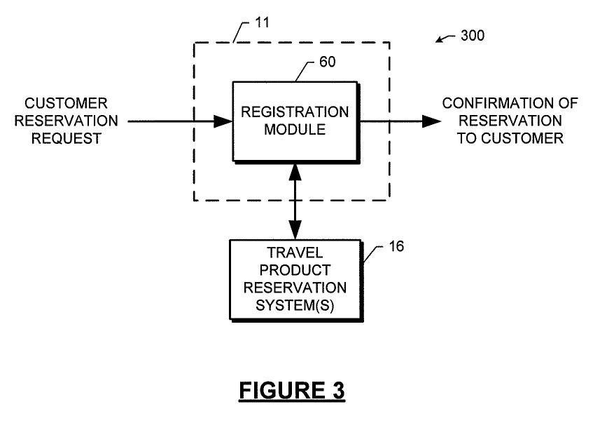

Referring now to FIG. 3, a block diagram is provided illustrating a system 300 configured for reserving one or more travel products in response to a customer's reservation request, in accordance with one embodiment of the present invention. In the illustrated embodiment, the travel planning system 11 includes a registration module 60. The reservation module 60 receives a customer reservation request and contacts a travel product reservation system 16 to request that a reservation be made pursuant to the customer's request. Where the travel product is a travel package comprising two or more travel components, the registration module 60 may need to contact a different travel product reservation system for each travel component. In one embodiment, the registration module 60 is configured to contact the reservation system operated by the supplier of the requested travel product. In other embodiments, the registration module 60 is configured to contact an intermediary entity, such as a GDS or a travel product purchasing entity configured to process financial transactions for the purchase of a travel product. Such an intermediary entity may be configured to accept reservation requests for the supplier of the requested travel product. In still other embodiments, the registration module 60 may be configured to submit the reservation request to the travel product cache system 12, which may then be configured to handle the reservation with the travel product reservation system 16. Although it may be more accurate and, therefore, preferred that the reservation system 16 that was used to populate the price and availability cache for a particular travel product is also the reservation system 16 that is used to make a reservation for that travel product, the registration module 60 need not make the reservation from the same travel product reservation system 16 that the price and availability information was received from. As described above, “reserving” one or more travel products may include purchasing the one or more travel products.

Once the reservation module 60 confirms that the travel product reservation system 16 has accepted the customer's reservation request, the registration module 60 may be configured to send a confirmation to the customer. Such a confirmation may be communicated on a web page shortly after the customer submits the reservation request, or a confirmation may be communicated to the customer via email, text message, telephone, or any other means.

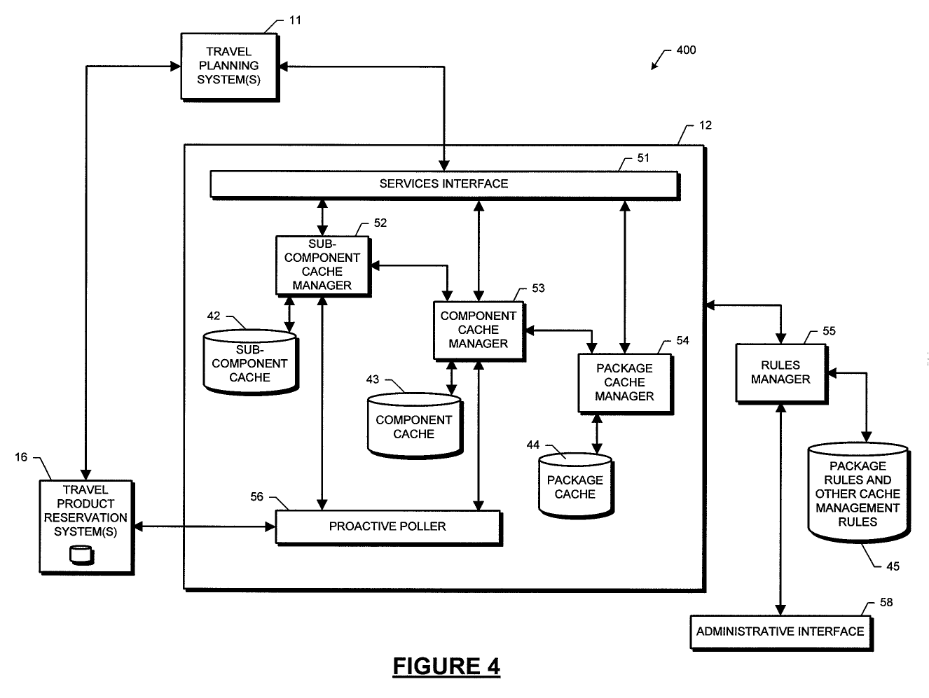

FIG. 4 provides a block diagram of a system 400 for generating and updating a cache of price and availability information for a plurality of travel products, in accordance with one embodiment of the present invention. As described above, the system 400 may include one or more travel planning system(s) 11, a travel product cache system 12, and one or more travel product reservation system(s) 16. One or more of these systems may be communicatively coupled to one or more of the other systems. As described above with respect to FIG. 2, the travel product cache system 12 may include a cache management system 50. In one embodiment, such as in the illustrated embodiment of FIG. 4, the cache management system 50 includes a services interface 51, a sub-component cache manager 52, a component cache manager 52, a package cache manager 54, a rules manager 55, and a proactive poller 56. The different components of the cache management system 50 may be executed by separate computers, processors, or devices or may be executed by the same computer, processor, or device.

As also described above with respect to FIG. 2, the travel product cache system 12 may include a price and availability cache 40. In the illustrated embodiment of FIG. 4, the price and availability cache 40 includes a sub-component cache 42, a component cache 43, and a package cache 44. The different components of the price and availability cache 40 may be stored in different memory devices or may be stored together in the same memory device, but as separate databases. The system 400 may further include a rules database 45 which may be stored in the same memory device as the price and availability cache 40 or a different memory device. As will be described in greater detail below, the rules database 45 may contain such rules as: package templates or other rules that the package cache manager 54 uses to generate travel packages; component rules that the component cache manager 53 may use to generate travel components; marketing rules such as price markup rules used to markup price information received from the travel reservation system(s) 16; and/or cache refreshing rules or schedules used by the various cache manager modules to proactively refresh their respective caches. The system 400 may also include an administrative interface 58 which may be used by an administrator or an administrative system to communicate with the rules manager 55 to generate or modify rules in the rules database 45. The proactive poller 56, the rules manager 55, the rules database 45, and the administrative interface 58 may or may not be considered components of the travel product cache system 12.

As illustrated in FIG. 4, the price and availability cache 40 of the travel product cache system 12 may include a separate travel component cache 43 and a separate travel package cache 44. The travel component cache 43 is a collection of price and availability information (and/or other information) for a plurality of travel components. The travel component cache 43 is managed by a travel component cache manager 53. When a customer accesses a travel planning system 11 and requests information about a travel component, such as a hotel reservation, the customer will typically submit a request to the travel planning system 11 that includes certain requested criteria, such as a requested geographic area, date, length of stay, type, class, rating, maximum price, minimum price, and the like. The travel planning system 11 may then submit a request to the travel product cache system 12 for the travel product cache system 12 to search for travel components that may satisfy the customer's request.

The travel product cache system 12 may include a services interface 51 that receives such search requests from the travel planning system 11. Upon receiving a search request from the travel planning system 11, the services interface 51 may submit a request to the component cache manager 53, the request instructing the component cache manager 53 to search the component cache 43 for price and availability information about one or more travel components related to the customer's criteria. The travel product cache system 12 may then provide the results of the travel component search to the travel planning system 11, where the results are presented to the customer in an appropriate way.

In one embodiment, if the component cache manager 53 does not find any results in the component cache 43 or if the results in the component cache are out-of-date compared to some benchmark date, then the component cache manager 53 may be further configured to use the proactive poller 56. The proactive poller 56 can be used by the component cache manager 53 to request price and availability information about one or more travel components from one or more travel product reservation systems 16. Thus, if the travel product cache system 12 receives a request for a certain travel component and does not have any substantially current information about the requested travel component in its travel component cache, the component cache manager 53 may use the proactive poller 56 to request information about the requested travel component from one or more appropriate travel product reservation systems 16. If a travel product reservation system 16 returns one or more travel components related to the proactive poller's request, then the component cache manager 53 may store the received information in the component cache 43 and provide at least some of this information to the travel planning system 11 in response to the travel planning system's request. If the travel component cache 43 and the travel product reservation system(s) 16 do not return any travel components, the travel product cache system 12 indicates such to the travel planning system 11, and the travel planning system 11 informs the customer that there are no travel components available that match the customer's requested criteria. As will be described below, in one embodiment, if the component cache manager 53 does not find any information in the component cache 43 that is relevant to the received travel component request, the component cache manager 53 may additionally or alternatively submit a request to a sub-component cache manager 52.

The travel package cache 44 is a collection of price and availability information (and/or other information) for a plurality of travel packages. The travel package cache 44 is managed by a travel package cache manager 54. As described above, a travel package is a combination of at least two travel components. In this regard, the system 400 may include a rules database 45 stored in a memory and the rules database 45 may include a plurality of package rules. The package rules of the rules database 45 may instruct the package cache manager 54 as to which travel components can be combined to market as a travel package. For example, the package rules may be embodied as templates that outline a package and specify the types of travel components that the package may contain. The package rules of the rules database 45 may also specify package pricing information that may determine a package price that is lower than the sum of the component prices had the components been purchased separately. For example, an exemplary package rule may specify that a package including an airline ticket from airline “A” may be able to apply a 10% discount to the hotel component of the package if the hotel component includes at least a three night stay at hotel “B,” “C,” or “D.”These package rules may be generated or updated by an administrative interface 58. In some embodiments (not shown), the rules manager 55 may be communicatively coupled to the one or more travel reservation systems 16 so that the rules manager 55 may receive package rules or other rules stored in the rules database 45 from one or more of the travel reservation systems 16.

When a customer accesses a travel planning system 11 and requests information about a travel package, such as a combined air, hotel, and car package, the customer will typically submit a request to the travel planning system 11 that includes certain requested criteria, such as a requested geographic area, date, and the like. The travel planning system 11 may then submit a request to the travel product cache system 12 for the travel product cache system 12 to search for travel packages that may satisfy the customer's request.

In this regard, the travel product cache system 12 may include a services interface 51 that receives such search requests from the travel planning system 11. Upon receiving a search request from the travel planning system 11, the services interface 11 may submit a request to the package cache manager 54, the request instructing the package cache manager 54 to search the package cache 44 for price and availability information about one or more travel packages related to the customer's criteria. The travel product cache system 12 may then provide the results of the travel package search to the travel planning system 11, where the results are presented to the customer in an appropriate way.

In one embodiment, if the package cache manager 54 does not find any results in the package cache 44 or if the results in the package cache have expired or are considered out-of-date compared to some benchmark date, then the package cache manager 54 may be further configured to contact the rules manager 55 and the component cache manager 53 to determine if a package can be generated that satisfies the customers request. For example, the package cache manager 54 may request package rules from the rules manager 55 that relate to the customer's request. The package cache manager 54 may then submit a request to the component cache manager 53 to obtain information about travel components needed to generate a package according to the customer's request and the relevant package rules. As described above, the component cache manager 53 receives the search request and searches the travel component cache 43. If the component cache manager 53 does not find any substantially current information about a travel component that satisfies the request, then the component cache manager 53 may use the proactive poller 56 to search one or more travel product reservation system(s) 16. Ultimately, if the package cache manager 54 determines that the requested package does not exist and cannot be generated pursuant to the package rules and the available travel components, the services interface 51 notifies the travel planning system 11 that the requested travel package is not available. In some embodiments, the travel planning system 11 and/or the travel product cache system 12 may be configured to search for and suggest alternative travel packages that are available.

In addition to or as an alternative to responding to customer or travel planning system requests for travel components and packages, in one embodiment the services interface 51 of the travel product cache system 12 is configured to proactively provide the travel planning system 11 with information about various travel components and/or travel packages. The travel planning system 11 may then provide information about one or more of these travel packages to the customers. For example, the travel product cache system 12 may send price and availability information for a plurality of highly-discounted travel packages to a travel planning system 11. The travel planning system 11 may then advertise these highly-discounted travel packages on its homepage, or the travel planning system 11 may be configured to email or otherwise provide a customer with information about one or more of these travel packages based on the customer's profile or on a prior travel product search made by the customer.

In some embodiments, one or more travel components supported by the system are made up of combinations of two or more travel sub-components. For example, price and availability information stored in the component cache 43 for a roundtrip or multi-city airline ticket may be comprised of price and availability information for two or more one-way tickets. In another example, price and availability information stored in the component cache 43 for a multi-night stay at a hotel may be made up of price and availability information for several one night stays at the hotel (or some other combination of several one or more night stays). As such, the travel product cache system 12 may also include a sub-component cache manager 52 and a sub-component cache 42, as illustrated in FIG. 4.

The sub-component cache manager 52 may be configured to perform functions similar to those described above with respect to the component cache manager 53. In this regard, the sub-component cache manager 52 may be configured to receive sub-component search requests from a customer, a travel planning system 11, or the component cache manager 53. For example, in one embodiment, the rules database 56 includes a component rule that specifies that the component cache manager 53 can generate an entry in the component cache 43 for a round trip flight between point “A” and point “B” by combining price and availability information for a one-way flight from “A” to “B” on airline “X” with a one-way flight from “B” to “A” on airline “Y.” In response to this rule, the component cache manager 53 may request price and availability information for each one-way flight from the sub-component cache manager 52 so that the component cache manager 53 may combine the price and availability information received for each one-way flight to generate price and availability information for the round trip flight, which the component cache manager 53 then stores in the travel component cache 43 as a round trip flight from “A” to “B” and back. Although the component cache 43 includes such a round trip flight as a travel component, in some embodiments the component cache 43 also includes each one-way trip as two other travel components.

In response to such search requests from the component cache manager 53 (or from a travel planning system 11 or a customer), the sub-component manager 52 may then search the sub-component cache 42 for travel sub-components that satisfy the search request. If the sub-component cache manager 52 finds appropriate sub-component information in the cache 42, then the sub-component information may be communicated to the requesting entity. However, in one embodiment, if the sub-component cache manager 52 does not find any relevant information or if the only information is out of date, then the sub-component manager 52 may be configured to use the proactive poller 56 to poll one or more travel reservation systems 16 for relevant sub-component information. The proactive poller module used by the sub-component cache manager 52 may be the same proactive poller module used by the component cache manager 53, as illustrated in FIG. 4, or the proactive poller module used by the two cache managers may be different from one another.

In some embodiments of the invention (not shown), one or more of the sub-components supported by the system are comprised of combinations of two or more travel sub-subcomponents. As such, some embodiments of the system 400 may include a sub-subcomponent manager and a sub-subcomponent cache. In other words, it should be apparent to one of ordinary skill in the art in view of this disclosure that additional layers of sub-components may be added to the cascading cache system as necessary depending on the types of travel products supported by the system and the requirements of the particular application.

Returning to the rules database 45, in addition to package rules and component rules, the rules database 45 may also include other types of cache management rules such as rules relating to when a package expires or when a package or a component can be considered “stale” or “out-of-date.” The rules stored in the database 45 may be generated and stored by the rules manager 55 in response to input received from the administrative interface 58. The rules manager 55 may then communicate these rules to the sub-component manager 52, the component manager 53, and/or the packager manager 54 as appropriate so that these manager modules may refresh their respective caches in accordance with these rules.

For example, as described above, a package rule may specify that a package including an airline ticket from airline “A” may be able to apply a 10% discount to the hotel component of the package if the hotel component includes at least a three night stay at hotel “B,” “C,” or “D.” Such a package rule may further specify a date or a period of time after which the 10% discount expires or the package rule expires. When such a date or period of time passes, the package manager 54 may update the package cache 44 accordingly by re-generating the relevant packages without the discount or by deleting these packages from the cache 44, as the case may be.

In another example, the rules database 45 may contain a rule that states that any price and availability information stored in the component cache 43 or the package cache 44 that has not been updated after some predefined time period must be refreshed or else deleted. For instance, a rule in the database 45 may instruct the component cache manager 53 to use the proactive poller 56 to update any entry in the component cache 43 that has not been updated in three days.

As illustrated in FIG. 4, the various cache manager modules 52 through 54 are communicatively coupled to one another to create a cascading cache structure. In this way, changes made to information in the sub-component cache 42 can be communicated to the component cache manager 53 so that the component cache manager 53 can change any information in the component cache 43 that is dependent on the changed information in the sub-component cache 42. Likewise, the changes made to information in the component cache 43 can be communicated to the package cache manager 54 so that the package cache manager 54 can change any information in the package cache 44 that is dependent on the changed information in the component cache 43. Of course, changes made in the package cache 44 must be made in accordance with any relevant package rules stored in the rules database 45.

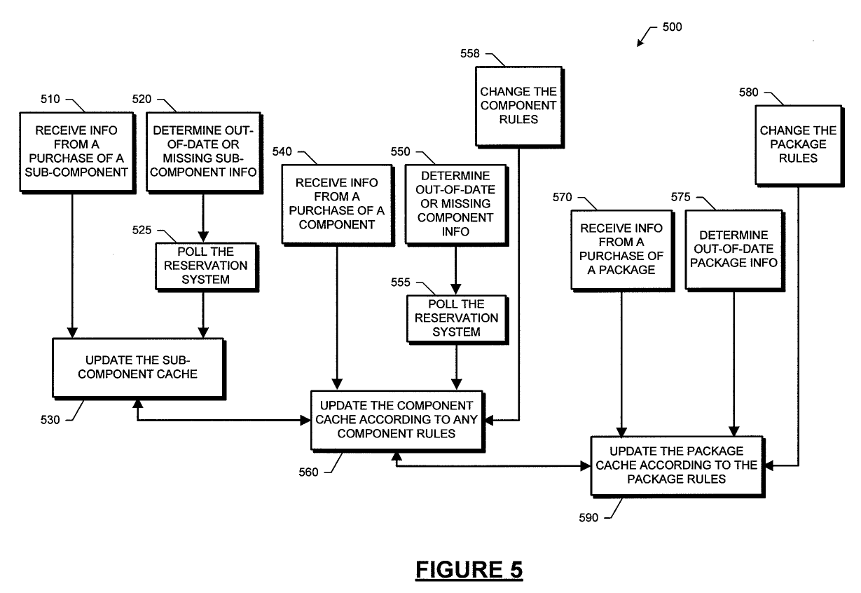

Just as changes can move in the general direction from the sub-component cache 42 to the package cache 44, changes can also flow the other way in the cascade. For example, changes made to the package rules in the rules database 45 can be communicated to the package cache manager 54 so that the package cache manager 54 can change any information in the package cache 44 that is dependent on the changed package rule. Changes to a package rule in the rules database 45 may also cause the package cache manager 54 to request information from the component cache manager 53 about one or more travel components needed to generate one or more new or updated packages. Such a request for information received by the component cache manager 53 may cause the component cache manager 53 to request information from the sub-component cache manager 52 about one or more relevant sub-components. Furthermore, as described in greater detail below with respect to FIG. 5, changes made to the package cache 44 may cause changes in the component cache 43, and changes in the component cache 43 may cause changes in the sub-component cache 42.

It should be appreciated, that having separate caches for travel packages, travel components, and travel sub-components can allow a travel planning system to search the appropriate cache and respond to a customer's request for a travel package, travel component, or travel sub-component in substantially less time than it would take for the travel planning system to search the various travel product reservation systems 16. As illustrated in FIG. 4, however, the travel planning system(s) 11 may be communicatively coupled to the travel product reservation system(s) 16 to allow a customer to purchase or reserve one or more travel products from a travel product reservation system 16. For example, after conducting a search for one or more travel products and reviewing the results of the search, a customer may wish to select a particular travel product and make a reservation. In the illustrated embodiment, the cache 40 used for checking price and availability information is not used during the actual purchase of the travel product. Instead, the travel planning system 11 queries the actual reservation system 16 to confirm that the price and availability information for the travel product that the customer selects. If there is availability, the travel planning system 11 makes the reservation for the customer and properly notifies the customer. If for some reason there is a discrepancy between the cache 40 and the availability of the travel product, such that the requested reservation is not available, the travel planning system 11 may return a non-availability response to the customer. Although FIG. 4 illustrates that the travel planning system 11 submits the reservation or purchase request to the travel product reservation system 16, in other embodiments, the travel planning system 11 may use the travel product cache system 12 or some other intermediate system for making the reservation or purchase request with the travel product reservation system 16.

It should also be appreciated that embodiments of the present invention provide systems, methods, and computer program products configured for generating a cache of price and availability data that may be more current than the cache used in a conventional system, while at the same time reducing the costs and/or processing delays associated with continuously requesting large amounts of price and availability information from the travel product reservation system(s) 16. In this regard, FIG. 5 illustrates a process 500 that may be executed by the system 400 of FIG. 4 to generate and/or update the travel product cache 40.

Referring to FIG. 5, a flow diagram is provided illustrating a method 500 for generating and/or updating price and availability information in the cache of FIG. 4, in accordance with one embodiment of the present invention. As illustrated, information in the sub-component cache 42 can generally be created or updated by two different processes. Block 510 illustrates the first process in which the sub-component cache manager 52 receives price and/or availability information (or other relevant information) from a purchase or reservation request of a travel sub-component.

For example, as described above, when a customer is browsing a plurality of travel products using, for example, a travel planning system 11, the customer may find a travel product, such as a travel sub-component, that the customer would like to purchase or reserve. As mentioned previously, when the customer is browsing or making queries for possible travel information, the cache system is used to provide search results. However, when the customer wishes to purchase or reserve a travel package or component, the system will poll the one or more reservation systems for real-time availability and pricing information. The customer may then request that the travel planning system 11 access the travel product reservation system 16 to purchase or reserve the travel product. When a reservation or a purchase is requested from the reservation system 16, real-time price and availability information about the travel product is provided in the form of a confirmation of the price and availability information and/or in the form of an actual purchase or reservation receipt received during or shortly after the purchase or reservation. This real-time information may then be received by the services interface 51 (e.g., by the travel planning system 11 communicating such information to the services interface 51) and then used to update the travel product cache 40.

In this regard, where the purchased or reserved travel product is a travel sub-component, the services interface 51 may communicate the information received form the purchase or the reservation request to the sub-component cache manager 52. The sub-component cache manager 52 may then use the purchase or reservation information to update price and availability information of one or more sub-components stored in the cache 42, as illustrated by block 530. For example, the fact that a purchase or reservation of a sub-component was made in itself may cause the sub-component cache manager 52 to decrement the number of such sub-components that are identified as available in the sub-component cache 42. Furthermore, the purchase or reservation request will generally provide real-time price and/or availability information that is more current and accurate than the price and availability information stored in the cache. Thus, the information received from a purchase or a reservation request of a sub-component is used by the sub-component cache manager 52 to update the price and availability information stored in the sub-component cache 42.

As described above and as also illustrated in FIG. 5, if the sub-component cache 42 is updated, the component cache 43 may also be updated in accordance with any component rules 45, as illustrated by block 560. For example, decrementing the number of available travel sub-components for a particular sub-component stored in the sub-component cache 42 may cause the component cache manager 53 to decrement the number of available travel components for any travel component in the travel component cache 43 whose availability is dependent upon the availability of the particular travel sub-component. Similarly, changes to the component cache 43 may then cause the system to update the package cache 44, according to the package rules 45, as illustrated by block 590.

Block 520 illustrates the second method that is used to update or generate information in the sub-component cache 42. In this method, the sub-component cache manager 52 determines records in the sub-component cache 42 that may be “out-of-date” and then uses the proactive poller 56 to poll the reservation system 16 to obtain updated information for that record, as illustrated by blocks 525 and 530. As described above, the rules database 45 may contain rules instructing the sub-component cache manger 52 as to how and when to generate new sub-component cache entries or how and when to otherwise refresh information stored in the component cache 42. In one embodiment, the sub-component cache manager 52 determines information in the cache 42 that may be out-of-date by comparing the amount of time it has been since the item in the sub-component cache 42 was last updated with some predefined maximum amount of time (which may, for example, be specified by a sub-component cache rule stored in the rules database 45). Thus, if an item of information in the sub-component cache 42 was recently updated based on information received from a recent purchase or reservation request, then the sub-component cache manager 52 may not need to poll the reservation system to update this item of information until some later time.

The sub-component cache manager 52 may also update the sub-component cache 42 by determining information that is “missing” from the sub-component cache 42. In other words, the sub-component cache manager 52 may use the proactive poller 56 to find information about new sub-component entries that have been added to the travel product reservation system(s) 16 but have yet to be added to the sub-component cache 42. As with any update to the sub-component cache 42, the updates can cascade through the cache system updating any information in the component cache 43 and the package cache 44 that relies on the new or changed information in the sub-component cache 42.

In another embodiment (not shown), the sub-component cache 42 may also be updated by the travel product reservation system(s) 16 “pushing” sub-component information to the sub-component cache manager 52. For example, in one embodiment, the sub-component cache manager 52 subscribes to an airline fare update system of a travel product reservation system 16, where the travel product reservation system 16 automatically provides the sub-component cache manager 52 with any new or changed fare information for all non-stop one-way flights. The sub-component cache manager 52 may then use this information to update the its cache 42 of price and availability information for non-stop one-way flights. The sub-component cache manager 42 may then communicate with the component cache manager 53 so that any of these changes to the sub-component cache 42 may be used to generate or update (in accordance with any component rules stored in the rules database 45) fare information for multi-city, round-trip, and/or one-way flights stored in the component cache 44 that are generated using fare information of non-stop one-way flights stored in the sub-component cache 42. The changes to the component cache 43 may then result in appropriate changes to the package cache 44. In this way, such an embodiment may update price and availability information for many travel components and travel packages without polling the travel product system 16 since all of these updates may be based on one fare change received at the sub-component level.

The processes that may be used by the component cache manager 53 to update the component cache 43 are generally similar to the processes described above with respect to updating the sub-component cache 42. As illustrated by block 540, the component cache 43 is updated based on information received from a purchase or reservation request for a travel component. As illustrated by blocks 550 and 555, the component cache manager 53 can also poll the travel product reservation system(s) 16 to find information about new travel components and to update information in the component cache 43 that has not been recently updated by purchase or reservation information. As described above, the rules database 45 may contain rules instructing the component cache manger 53 as to how and when to generate new component cache entries or how and when to otherwise refresh information stored in the component cache 43. Furthermore, where component rules stored in the rules database 45 are used to generate travel component data from combinations of sub-component data, a change to the sub-component cache 42 may cause the component cache manger 53 to make one or more changes in the component cache 43 in accordance with the component rules received from the rules database 45. As illustrated by block 558, where component rules stored in the rules database 45 are used to generate travel component data from combinations of sub-component data, a change to the component rules stored in the rules database 45 may also cause changes to the component cache 43. As illustrated by blocks 530, 560, and 590 and the arrows therebetween, updates to the component cache 43 may be used to update related information in the sub-component cache 42 and the package cache 44.

It should be appreciated that, in a preferred embodiment, there is enough volume of purchase and reservation requests to update a substantial percentage of the cache 40 without the travel product cache system 12 having to proactively poll the travel product reservation system(s). In such an embodiment, the cache management system 50 can use the proactive poller 56 to “fill in the gaps” in the updates to the cache 40 by only polling the reservation system(s) 16 to find new travel product information for the cache or to update information in the cache that has not been recently updated by purchase or a reservation information. In this way, the information in the cache 40 can stay substantially current without the travel product cache system 12 having to proactively poll the reservation system(s) 16 to update each and every record in the cache 40.

As with the sub-component cache manager 52 and the component cache manager 53, in one embodiment, the package cache manager 54 can update package information in the package cache 44 based on information received from a purchase or a reservation request for a travel package, as illustrated by block 570. The changes made to the package cache 44 can also be used to make changes to component cache 43 and, thereby, the sub-component cache 42. For example, the number of available travel packages for a certain type of travel package can be decremented by the number of purchased travel packages of that type. Furthermore, since a travel package necessarily includes at least one travel component or travel sub-component, the number of available travel components or sub-components for the particular travel components or sub-components included in the package can be decremented in the component cache 43 or sub-component cache 42. Price information and other information received during the purchase or reservation request of a travel package can also be used to update the package, component, and sub-component caches.

As illustrated by block 575, the package cache manager 54 can also update the package cache 44 by determining out-of-date travel package entries. For example, the package rules stored in the package rules cache 45 may indicate a predefined expiration date for a travel package or some discount used to generate the package price. The package cache manager 54 may be configured to make any expired travel package unavailable or to appropriately alter one or more packages after the expiration of a particular promotion. As illustrated by block 580, the package cache 44 can also be updated (i.e., existing travel packages can be changed and new travel packages can be added) based on changes to the package rules stored in the package rules cache 45.

According to one aspect of the present invention, the system, or at least portions of the system, generally operates under control of a computer program product. The computer program product for performing the methods of embodiments of the present invention includes a computer-readable storage medium, such as the memory device associated with a processing element, and computer-readable program code logic, such as a series of computer instructions, embodied in the computer-readable storage medium.

In this regard, FIGS. 2-5 are block diagrams and flow diagrams of methods and computer program products according to embodiments of the present invention. It will be understood that each block or step of the diagrams, and combinations of blocks or steps in the diagrams, can be implemented by computer program instructions. These computer program instructions may be loaded onto a processing element, such as a computer, server, or other programmable apparatus, to produce a machine, such that the instructions which execute on the processing element create means for implementing the functions specified in the block(s) or step(s) of the diagrams. These computer program instructions may also be stored in a computer-readable memory that can direct the processing element to function in a particular manner, such that the instructions stored in the computer-readable memory produce an article of manufacture including instruction means which implement the function specified in the block(s) or step(s) of the diagrams. The computer program instructions may also be loaded onto the processing element to cause a series of operational steps to be performed on the processing element to produce a computer implemented process such that the instructions which execute on the processing element provide steps for implementing the functions specified in the block(s) or step(s) of the diagrams.

Accordingly, blocks or steps of the block diagrams and flow diagrams support combinations of means for performing the specified functions, combinations of steps for performing the specified functions, and program instruction means for performing the specified functions. It will also be understood that each block or step of the diagrams, and combinations of blocks or steps in the diagrams, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for generating and/or updating price and availability information of travel packages, each travel package comprising a combination of at least two travel components, the system comprising:
a memory system configured for storing data;
a component cache manager module configured for managing a component cache of price and availability information for each of a plurality of travel components, the component cache stored within the memory system; and
a package cache manager module in operative communication with the component cache manager module and configured for managing a package cache of price and availability information for each of a plurality of travel packages, the package cache stored within the memory system,
wherein the package cache manager module is configured to receive an indication of a change made to price and availability information in the component cache, and
wherein the package cache manager module is configured to update or generate price and availability information of a travel package in the package cache based on the change to the component cache.

2. The system of claim 1, further comprising:
a polling module in operative communication with the component cache manager module and configured for polling one or more travel product reservation systems in order to receive current price and availability information about one or more travel components,
wherein the component cache manager module is configured to use the polling module to periodically update at least some of the component cache.

3. The system of claim 2, wherein the component cache manager module is configured to use the polling module to update an item of information in the component cache when the item of information has not been updated for a predetermined amount of time.

4. The system of claim 2, wherein the component cache manager module is further configured to update at least some of the component cache based on information received from a purchase or reservation request for at least one travel component.

5. The system of claim 2, wherein at least one of the one or more travel product reservation systems comprises a Global Distribution System.

6. The system of claim 1, wherein the component cache manager module is configured to update the component cache based on information received from a purchase or reservation request for at least one travel component.

7. The system of claim 1, wherein the package cache manager module is configured to update the package cache based on information received from the purchase or reservation request for a travel package.

8. The system of claim 7, wherein the information received from a purchase or reservation request for a travel package is used to update the component cache.

9. The system of claim 1, further comprising:
a sub-component cache manager module in operative communication with the component cache manager module and configured for managing a sub-component cache of price and availability information for each of a plurality of travel sub-components, the sub-component cache stored within the memory system,
wherein the component cache manager module is configured to receive an indication of a change made to the sub-component cache, and
wherein the component cache manager module is configured to generate or update the price and availability information of a travel component in the component cache based on the change made to the sub-component cache.

10. The system of claim 1, further comprising:
a rules manager module configured for managing a plurality of package rules, wherein the package rules are stored in the memory system, and wherein the package cache manager module generates or updates travel packages in the package cache according to the package rules.

11. The system of claim 1, further comprising:
a services interface configured to: receive, from a requesting entity, requests for price or availability information for one or more travel components or travel packages; use the component cache manage module or the package cache manager module to search for the requested price or availability information in the component cache or the package cache; and provide price or availability information to the requesting entity in response to the request.

12. The system of claim 1, wherein the system is configured to provide price and availability information for a travel component or a travel package in response to a request from one or more online travel planning systems.

13. A method for generating and/or updating price and availability information of travel packages, each travel package comprising a combination of at least two travel components, the method comprising:
providing a memory system configured for storing data;
storing in the memory system a component cache of price and availability data for a plurality of travel components;
storing in the memory system a package cache of price and availability data for a plurality of travel packages; and
updating or generating price and availability information of a travel package in the package cache based on a change to the component cache.

14. The method of claim 13, further comprising:
polling one or more travel product reservation systems in order to receive current price and availability information about one or more travel components; and
updating or generating at least some of the price and availability information in the component cache based on the received current price and availability information.

15. The method of claim 14, further comprising:
polling one or more travel product reservation systems to update an item of information in the component cache when the item of information has not been updated for a predetermined amount of time.

16. The method of claim 14, further comprising:
updating at least some of the component cache based on information received about a purchase or reservation request for at least one travel component.

17. The method of claim 14, wherein at least one of the one or more travel product reservation systems comprises a Global Distribution System.

18. The method of claim 13, further comprising:
updating the component cache based on information received about a purchase or reservation request for at least one travel component.

19. The method of claim 13, further comprising:
updating the package cache based on information received about a purchase or reservation request for a travel package.

20. The method of claim 19, further comprising:
using the information received about a purchase or reservation request for a travel package to update the component cache.

21. The method of claim 13, further comprising:
storing in the memory system a sub-component cache of price and availability information for a plurality of travel sub-components; and
generating or updating price and availability information of a component in the component cache based on a change made to the sub-component cache.

22. The method of claim 13, further comprising:
storing a plurality of package rules in the memory system; and
generating or updating travel packages in the package cache according to the package rules.

23. The method of claim 13, further comprising:
receiving, from a requesting entity, requests for price or availability information for one or more travel components or travel packages;
searching for the requested price or availability information in the component cache or the package cache; and
providing price or availability information to the requesting entity in response to the request.

24. A computer program product for generating and/or updating price and availability information of travel packages, each travel package comprising a combination of at least two travel components, the computer program product comprising at least one computer-readable storage medium having computer-readable program code logic stored therein, the computer-readable program code logic comprising:
a first code logic configured for storing in a memory system a component cache of price and availability data for a plurality of travel components;
a second code logic configured for storing in the memory system a package cache of price and availability data for a plurality of travel packages; and
a third code logic configured for updating or generating price and availability information of a package in the package cache based on a change to the component cache.

25. The computer program product of claim 24, further comprising:
a fourth code logic configured for polling one or more travel product reservation systems in order to receive current price and availability information about one or more travel components; and
a fifth code logic configured for updating or generating at least some of the price and availability information in the component cache based on the received current price and availability information.

26. The computer program product of claim 25, further comprising:
a sixth code logic configured for polling one or more travel product reservation systems to update an item of information in the component cache when the item of information has not been updated for a predetermined amount of time.

27. The computer program product of claim 25, further comprising:
a sixth code logic configured for updating at least some of the component cache based on information received about a purchase or reservation request for at least one travel component.

28. The computer program product of claim 25, wherein at least one of the one or more travel product reservation systems comprises a Global Distribution System.

29. The computer program product of claim 24, further comprising:
a fourth code logic configured for updating the component cache based on information received about a purchase or reservation request for at least one travel component.

30. The computer program product of claim 24, further comprising:
a fourth code logic configured for updating the package cache based on information received about a purchase or reservation request for a travel package.

31. The computer program product of claim 30, further comprising:
a fifth code logic configured for using the information received about a purchase or reservation request for a travel package to update the component cache.

32. The computer program product of claim 24, further comprising:
a fourth code logic configured for storing in the memory system a sub-component cache of price and availability information for a plurality of travel sub-components; and
a fifth code logic configured for generating or updating price and availability information of a component in the component cache based on a change made to the sub-component cache.

33. The computer program product of claim 24, further comprising:
a fourth code logic configured for storing a plurality of package rules in the memory system; and
a fifth code logic configured for generating or updating travel packages in the package cache according to the package rules.

34. The computer program product of claim 24, further comprising:
a fourth code logic configured for receiving, from a requesting entity, requests for price or availability information for one or more travel components or travel packages;
a fifth code logic configured for searching for the requested price or availability information in the component cache or the package cache; and
a sixth code logic configured for providing price or availability information to the requesting entity in response to the request.
